(19) United States
(12) Patent Application Publication
(10) Pub. No.: US 2022/0198913 A1
(43) Pub. Date: Jun. 23, 2022

(54) SECURITY SYSTEMS AND METHODS OF OPERATION

(71) Applicant: Gallagher Group Limited, Hamilton (NZ)

(72) Inventors: Patricia Monica THOMPSON, Hamilton (NZ); Sandra Ann GILCHRIST, Hamilton (NZ); Steven John BELL, Hamilton (NZ)

(73) Assignee: Gallagher Group Limited, Hamilton (NZ)

(21) Appl. No.: 17/608,444

(22) PCT Filed: May 4, 2020
(86) PCT No.: PCT/NZ2020/050041

§ 371 Date: Nov. 2, 2021

(30) Foreign Application Priority Data
May 2, 2019 (NZ) 753100

(51) Int. Cl. G08B 25/00; G08B 29/12; G08B 27/00

(52) U.S. Cl. CPC G08B 25/008; G08B 27/001; G08B 29/12

(57) ABSTRACT

A security system and methods for managing same are disclosed. The security system include an on-site security system including one or more alarm condition sensors and at least one site control unit configured to communicate with the alarm condition sensors, and a security management service located remotely from the on-site security system and configured to communicate with the site control unit and at least one authorised user associated with the on-site security system. The service issues an alarm notification to at least one authorised user, the alarm notification identifying at least a sensor triggering issuance of the alarm notification, a location of the sensor, and a time of the sensor being triggered. The service monitors for acknowledgement of the alarm notification from the authorised user, and issues a response request to at least one security responder in the absence of an acknowledgement.

### STATEMENT OF CORRESPONDING APPLICATIONS

This application is based on the Provisional specification filed in relation to New Zealand Patent Application No. 753100, the entire contents of which are incorporated herein by reference.

### TECHNICAL FIELD

The present disclosure relates to security technologies, and more particularly security installations in which alarm notifications are issued to user devices and methods for managing same.

### BACKGROUND

Physical security systems are widely known for detecting alarm conditions at a site and issuing alerts to monitoring stations or to authorized users. Advancements in communications technology and increasing levels of connectivity means that such alerts can be delivered with a relatively high degree of certainty of being received by the intended recipients.

However there remains room for improvement, particularly with regard to ease and clarity of establishing responsibility for actioning a response to such alerts and providing complete and accurate recording-keeping of activity associated with an alarm event.

Further, in many instances sites having such security systems will also have other site management systems in place, for example providing access control. The effectiveness of a response will be influenced by the ability of a responder to navigate such site management systems, balanced against a desire to avoid compromising the integrity of the site's security.

Aspects of the technology of the present disclosure are directed to overcoming one or more of the problems discussed above. It is an object of the present invention to address one or more of the foregoing problems or at least to provide the public with a useful choice.

Further aspects and advantages of the present disclosure will become apparent from the ensuing description which is given by way of example only.

### SUMMARY

According to one aspect of the present technology there is provided a security system including:

an on-site security system including:
one or more alarm condition sensors;
one or more access control devices; and
at least one site control unit configured to communicate with the alarm condition sensors and the access control devices; and

a security management service located remotely from the on-site security system, configured to communicate with the site control unit and at least one authorised user associated with the on-site security system.

According to one aspect of the present technology there is provided a security system including:

an on-site security system including:
one or more alarm condition sensors; and
at least one site control unit configured to communicate with the alarm condition sensors and the access control devices; and

a security management service located remotely from the on-site security system and configured to communicate with the site control unit and at least one authorised user associated with the on-site security system, the security management service including one or more processors and one or more non-transitory computer-readable media that collectively store instructions that when executed by the one or more processors cause the service to perform operations including:

issuing an alarm notification to the at least one authorised user, the alarm notification identifying at least: the alarm condition sensor triggering issuance of the alarm notification, a location of the alarm condition sensor, and a time of the alarm condition sensor being triggered;

monitoring for acknowledgement of the alarm notification from the authorised user; and

issuing a response request to at least one security responder in the absence of an acknowledgement.

A computer-implemented method of managing an alarm event using a security system including an on-site security system including one or more alarm condition sensors and at least one site control unit configured to communicate with the alarm condition sensors, and a security management service located remotely from the on-site security system and configured to communicate with the site control unit and at least one authorised user associated with the on-site security system, the method including: issuing an alarm notification to at least one authorised user, the alarm notification identifying at least: a sensor triggering issuance of the alarm notification, a location of the sensor, and a time of the sensor being triggered; monitoring for acknowledgement of the alarm notification from the authorised user; and issuing a response request to at least one security responder in the absence of an acknowledgement, wherein the response request directs the at least one security responder to attend a site location associated with the on-site security system.

According to one aspect of the present technology there is provided at least one user interface for communication with the security management service to perform one or more of: establishing one or more user profiles, editing privileges of each user profile regarding the on-site security system, issuing notifications regarding events within the security system, viewing details of the events, claiming responsibility for the events, providing updates on the events, enabling requests for external services to be made, and reporting.

According to one aspect of the present technology there is provided a user device configured to provide the at least one user interface.

According to one aspect of the present technology there is provided a method of notifying at least one user of an alarm event, the method including:

issuing an alarm notification to at least one authorised user, the alarm notification identifying at least: a sensor triggering issuance of the alarm notification, a location of the sensor, and a time of the sensor being triggered,

wherein the alarm notification further includes an indication of a likelihood of the alarm notification relating to a false alarm event.

According to one aspect of the present technology there is provided a method of managing an alarm event, the method including:

issuing an alarm notification to at least one authorised user, the alarm notification identifying at least: a sensor triggering issuance of the alarm notification, a location of the sensor, and a time of the sensor being triggered;

receiving acknowledgement of the alarm notification from the authorised user, the acknowledgment identifying the individual making the acknowledgement, and a time of the acknowledgment; and

issuing a response request to at least one security responder.

According to one aspect of the present technology there is provided a method of managing an alarm event, the method including:

issuing an alarm notification to at least one authorised user, the alarm notification identifying at least: a sensor triggering issuance of the alarm notification, a location of the sensor, and a time of the sensor being triggered;

monitoring for acknowledgement of the alarm notification from the authorised user; and

issuing a response request to at least one security responder in the absence of an acknowledgement.

According to one aspect of the present technology there is provided a method for access control, including:

receiving an arrival notification from a security responder advising arrival at a location having an access control system following issuance of a response request resulting from generation of an alarm notification;

deactivating at least a portion of the access control system;

receiving a departure notification from the security responder advising intended departure from the location; and

activating the access control system.

In examples, the location may include a security alarm system. The location may be referred to herein as a site-location. On receiving the arrival notification, at least a portion of the security alarm system may be deactivated. Similarly, on receiving the departure notification the security alarm system may be activated. In examples, the security alarm system may be activated automatically in the absence of a departure notification an on at least one predetermined condition being met—for example on determining that the security responder has exited the site (such as using geolocation tracking), or on a predetermined period of time expiring. It is also contemplated that such control may be provided in examples in which the location does not implement an access control system—i.e. only a security alarm system is present.

According to one aspect of the present technology there is provided a method for access control, including:

receiving an arrival notification from a security responder advising arrival at a location implementing an access control system following issuance of a response request resulting from generation of an alarm notification;

activating access control permissions of a device of the security responder, the access control permissions allowing at least partial control of the access control system;

receiving a departure notification from the security responder advising intended departure from the location; and

disabling the access control permissions of the device of the security responder.

In examples, the location may include a security alarm system. On receiving the arrival notification, security alarm permissions of the device of the security responder may be activated, allowing at least partial control of the security alarm system. Similarly, on receiving the departure notification the security alarm permissions may be deactivated. In examples, the security alarm permissions may be automatically deactivated in the absence of a departure notification. It is also contemplated that such control may be provided in examples in which the location does not implement an access control system—i.e. only a security alarm system is present.

In examples, issuing a response request to at least one security responder may include selecting between a plurality of potential security responders based on one or more characteristics. In examples the one or more characteristics may include: an indication of availability, price, an indicator of likely response time, a customer satisfaction rating, and one or more performance metrics based on responses to prior events.

According to one aspect of the present technology there is provided a method of managing an alarm event, the method including:

determining a location of at least one sensor triggering issuance of an alarm notification within a site in which the sensor is installed; and

communicating an indication of the location to a security responder who has been requested to attend the site in response to the alarm notification.

The location of the at least one sensor within the site location may be referred to herein as an in-site location.

According to one aspect of the present technology there is provided a method of generating an incident report, the method including:

issuing an alarm notification to at least one authorised user, the alarm notification identifying at least: a sensor triggering issuance of the alarm notification, a location of the sensor, and a time of the sensor being triggered;

receiving acknowledgement of the alarm notification from the authorised user, the acknowledgment identifying the individual making the acknowledgement, and a time of the acknowledgment;

issuing a response request to at least one security responder;

receiving at least one notification of security responder activity, including details of at least: time of acknowledging the response request, time of arrival at a location associated with the alarm notification, and time of departing the location; and

generating an incident report, including a sequential record of the issuance of the alarm notification, the acknowledgement of the alarm notification, the issuance of the response request, and the at least one notification of security responder activity.

A method for attending to payment of an external provider's services, including:

receiving a request for an external provider's services;

recording external provider activity, including a confirmation of the external provider initiating the service, and a confirmation of the external provider concluding the service;

receiving a request for payment from the external provider;

verifying the request for payment through the recorded external provider activity; and

charging the customer.

A method for attending to payment of security services, including:

receiving a request for a security responder to attend a customer's site having an associated alarm notification;

recording security responder activity, including a confirmation of the security responder attending the site, and a confirmation of the security responder exiting the site;

receiving a request for payment from a security provider associated with the security responder;

verifying the request for payment through the recorded security responder activity; and charging the customer.

The above and other features will become apparent from the following description and the attached drawings.

### BRIEF DESCRIPTION OF THE DRAWINGS

Further aspects of the present disclosure will become apparent from the following description which is given by way of example only and with reference to the accompanying drawings in which:

FIG. 1 is a block diagram of an exemplary system according to one aspect of the present technology.

FIGS. 2-1 to 2-3 are schematic diagrams of site layouts of on-site security systems according to one aspect of the present technology.

FIGS. 3-1 and 3-2 are exemplary user-interfaces for administrating user privileges in the system of FIG. 1.

FIGS. 4-1 to 4-4 are exemplary user-interfaces for arming and disarming elements of the system of FIG. 1.

FIGS. 5-1 and 5-2 are exemplary user-interfaces for managing alarm events in the system of FIG. 1.

FIG. 6 is an exemplary user-interface for reporting events in the system of FIG. 1.

FIG. 7-1 is a flowchart illustrating an exemplary process for requesting a security response in the system of FIG. 1.

FIG. 7-2 is a diagram demonstrating determination of security responder availability according to one aspect of the present technology.

FIG. 8-1 is a flowchart illustrating another exemplary process for requesting a security response in the system of FIG. 1.

FIG. 8-2 is an exemplary user-interface displaying an event record according to one aspect of the present technology.

FIG. 9 is a flowchart illustrating an exemplary process for providing a security responder access to a site.

FIG. 10 is a flowchart illustrating an exemplary method for fulfilment of a payment request.

### DETAILED DESCRIPTION

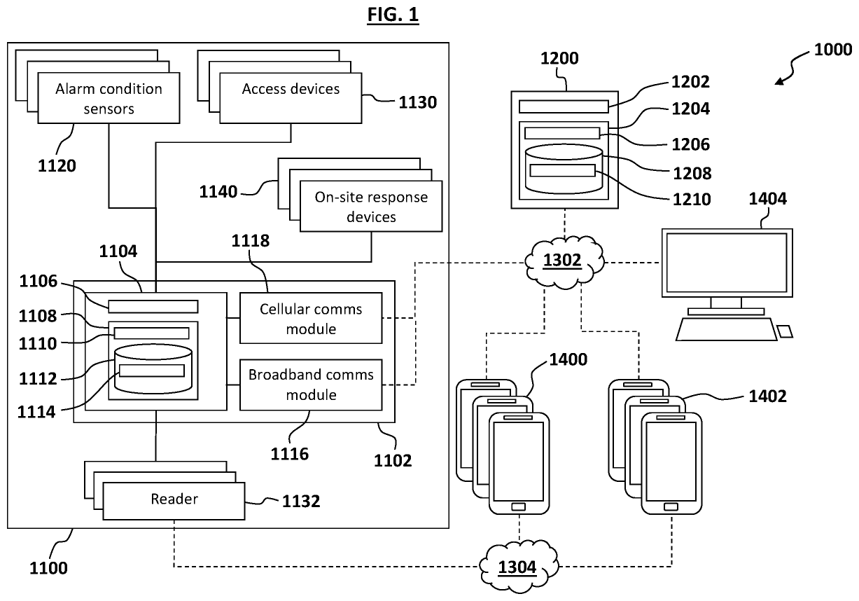

FIG. 1 illustrates an exemplary system 1000 in which aspects of the present disclosure may be provided. In an exemplary embodiment, an on-site security system 1100 includes a site control unit 1102. The control unit 1102 includes at least one controller 1104 having one or more processors 1106, memory 1108, and other components typically present in such computing environments. In the exemplary embodiment illustrated the memory 1108 stores information accessible by processors 1106, the information including instructions 1110 that may be executed by the processors 1106 and data 1112 that may be retrieved, manipulated or stored by the processors 1106. The memory 1108 may be of any suitable means known in the art, capable of storing information in a manner accessible by the processors, including a computer-readable medium, or other medium that stores data that may be read with the aid of an electronic device. The processors 1106 may be any suitable device known to a person skilled in the art. Although the processors 1106 and memory 1108 are illustrated as being within a single unit, it should be appreciated that this is not intended to be limiting, and that the functionality of each as herein described may be performed by multiple processors and memories, that may or may not be remote from each other.

The instructions 1110 may include any set of instructions suitable for execution by the processors 1106. For example, the instructions 1110 may be stored as computer code on the computer-readable medium. The instructions may be stored in any suitable computer language or format. Data 1112 may be retrieved, stored or modified by processors 1106 in accordance with the instructions 1110. The data 1112 may also be formatted in any suitable computer readable format. Again, while the data is illustrated as being contained at a single location, it should be appreciated that this is not intended to be limiting—the data may be stored in multiple memories or locations. The data 1112 may include databases 1114 storing data relating to operation of the on-site security system 1100, for example access privileges, alarm protocols, and historical information relating to events within the system 1100.

The control unit 1102 may include a first communications module 1116 configured to communicate using a first type of communications (for example, via a broadband connection—whether via a WiFi connection and/or ethernet connection), and a second communications module 1118 configured to communicate using a second type of communications (for example, via a cellular network connection).

The on-site security system 1100 includes one or more alarm condition sensors 1120 configured to communicate with the control unit 1102 to provide data that may be used to detect occurrence of a security event. Examples of such alarm condition sensors 1120 may include: motion detectors for detecting motion within an area (e.g. PIR motion detectors), door/window detectors for detecting opening and/or closing of a door/window (e.g. reed switches), smoke and/or gas and/or heat detectors, video cameras (which may also provide motion detection capabilities, and image recognition capabilities) and associated recording capabilities (for example, a network video recorder), and security fences with tamper and/or attempted breach detection capabilities (for example via sensing of electrical fence characteristics, vibration sensors, and/or tension sensors).

The on-site security system 1100 further includes one or more access control devices 1130 configured to control access to areas within the site, and in communication with the control unit 1102. Examples of such access control devices 1130 may include: readers 1132 configured to read devices providing access privileges (e.g. card and/or Bluetooth/NFC enabled devices), biometric readers (e.g. via finger, iris, or facial recognition), keypads, request to exit devices (e.g. push buttons), and electronic locks (e.g. mortise or magnetic) controlled by same.

The on-site security system 1100 further includes one or more on-site response devices 1140 controllable by the control unit 1102 to be activated in response to determination of a security event being in progress. Examples of such on-site response devices 1140 may include devices to act as a deterrent to an intruder (or draw attention to the presence of an intruder), such as a siren, a strobe, or a floodlight.

FIGS. 2-1 to 2-3 are exemplary layouts of premises 2000 in which the on-site security system 1100 is installed. Each premises may include a number of zones, for example first zone 2002, second zone 2004, third zone 2006, fourth zone 2008. Each zone may be named within the system 1000 in order that it may be readily identified in communications with customer personnel and/or security personnel. As illustrated, various alarm condition sensors 1120 are distributed about the premises 2000, for example PIR motion detectors 1122, reed switches 1124, smoke/gas/heat detectors 1126, video cameras 1128, and monitored security fences 1129. Access control devices 1130 are provided in the form of readers 1132, mortise locks 1134, and magnetic locks 1136. It should be appreciated that while mortise locks 1134 and magnetic locks 1136 are not depicted in the first premises 2000-1 or second premises 2000-2, these may be provided at access points associated with the readers 1132 depicted. On-site response devices 1140 are also provided in the form of siren/strobe unit 1142 and sirens 1144.

Returning to FIG. 1, in exemplary embodiments the control unit 1102 may communicate with a security management service 1200 via a network 1302 (for example a cellular network, or another network potentially comprising various configurations and protocols including the Internet, intranets, virtual private networks, wide area networks, local networks, private networks using communication protocols proprietary to one or more companies—whether wired or wireless, or a combination thereof). The dual communications modules 1116 and 1118 allows for connection in the event of failed connection via one of the communication paths. For example, a broadband network connection may be the primary communication path, with automated failover to a cellular network connection.

It is envisaged that the security management service 1200 may control the control unit 1102 and facilitate communications with various parties, including individuals associated with the site in which the on-site security system 1100 is installed (the owner/operator of the site will be referred to herein as the “customer”), security response providers (for example, contracted security services), and potentially emergency response services. However, the control unit 1102 may be configured to operate in an off-line mode in the absence of a connection to the security management service 1200. For example, the control unit 1102 may maintain a local record of alarm condition and access control protocols, and record incidents occurring within the on-site security system 1100, until a connection can be re-established, and updates made.

In this exemplary embodiment, the security management service 1200 is illustrated as being implemented in a server—for example one or more dedicated server devices, or a cloud-based server architecture. By way of example, cloud servers implementing the data management service 1200 may have processing facilities represented by processors 1202, memory 1204, and other components typically present in such computing environments. In the exemplary embodiment illustrated the memory 1204 stores information accessible by processors 1202, the information including instructions 1206 that may be executed by the processors 1202 and data 1208 that may be retrieved, manipulated or stored by the processors 1202. The memory 1204 may be of any suitable means known in the art, capable of storing information in a manner accessible by the processors, including a computer-readable medium, or other medium that stores data that may be read with the aid of an electronic device. The processors 1202 may be any suitable device known to a person skilled in the art. Although the processors 1202 and memory 1204 are illustrated as being within a single unit, it should be appreciated that this is not intended to be limiting, and that the functionality of each as herein described may be performed by multiple processors and memories, that may or may not be remote from each other. The instructions 1206 may include any set of instructions suitable for execution by the processors 1202. For example, the instructions 1206 may be stored as computer code on the computer-readable medium. The instructions may be stored in any suitable computer language or format. Data 1208 may be retrieved, stored or modified by processors 1202 in accordance with the instructions 1206. The data 1208 may also be formatted in any suitable computer readable format. Again, while the data 1208 is illustrated as being contained at a single location, it should be appreciated that this is not intended to be limiting—the data may be stored in multiple memories or locations. The data 1208 may include databases 1210 storing data associated with components and dataflows within the wider system 1000. It should be appreciated that in exemplary embodiments the functionality of the security management service 1200 described herein may be realized in a local application, or a combination of local and remote applications.

In exemplary embodiments, the security management service 1200 is configured to communicate with user devices, for example mobile devices such as customer smartphones 1400 of customers of the security service, and responder smartphones 1402 of one or more security response providers. For example, smartphones 1400 and 1402 may operate an application capable of interfacing with the security management service 1200. In examples, smartphones 1400 and 1402 may be provided with credentials which may be read by reader 1132 to communicate with the control unit 1102, even in the absence of communications via the broadband connection or the cellular network connection. Functions of the security management service 1200 may also be accessed via a user workstation 1404—for example, via a web-application accessed through a web browser.

In examples, the security management service 1200 may communicate directly with emergency response services, more particular police. It should be appreciated that aspects of the present technology described herein with regard to use by, or interaction with, security responders may also be applicable for use with emergency services. In examples, additional layers of user confirmation may be required before communicating with emergency response services (for example, an additional confirmation step requiring positive selection by a user) to assist with reducing the likelihood of such services being called to a false alarm.

The security management service 1200 may maintain a plurality of user profiles for each customer and/or installation, each user profile containing information pertaining to individuals and their associated permissions and roles within the system 1000. For example, a user profile may include contact information, access credentials, system privileges, and devices 1400 registered as being associated with the individual.

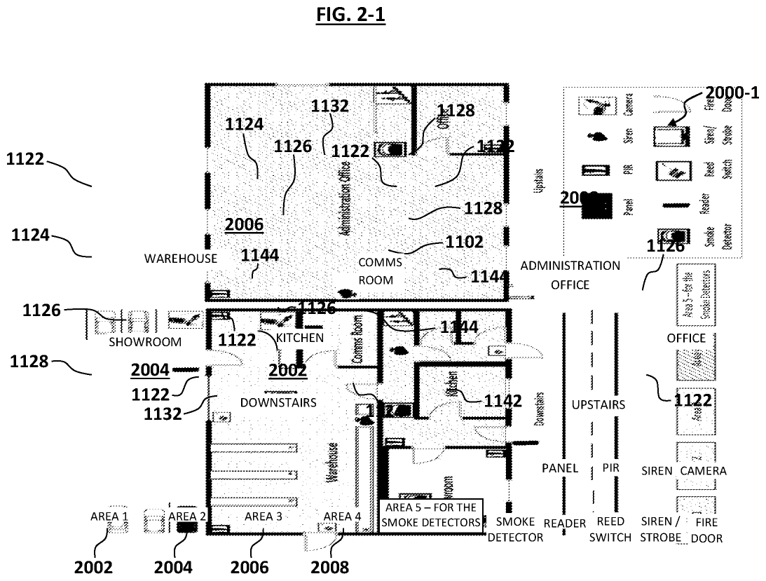

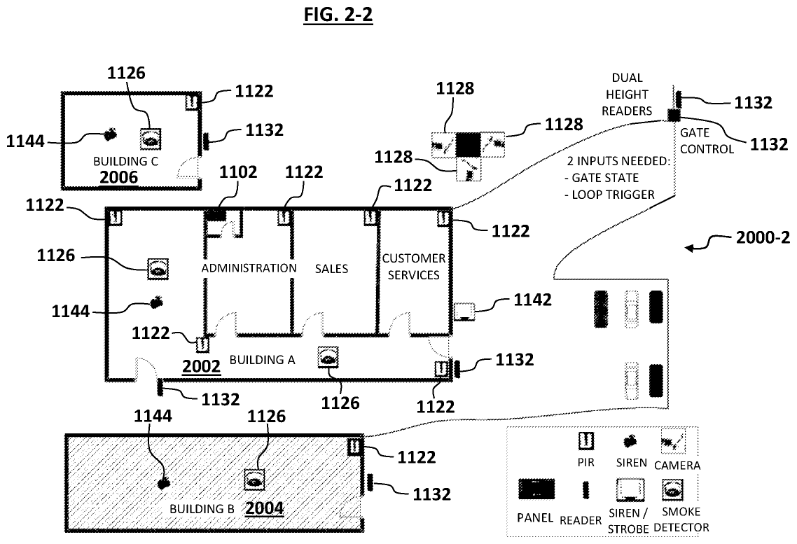

FIG. 3-1 shows a first user interface 3000 of an app operating on a customer smartphone 1400, where the user has administrator privileges allowing them to add and edit user profiles. For example, selecting a first user profile 3002 in the first user interface 3000 displays a delete option 3004, an invite option 3006 (selection of which transmits an invitation to the user to install the app on their smartphone 1400), and an edit option 3008. Selection of the edit option 3008 displays a second user interface 3020 as shown in FIG. 3-2. User details tab 3022 may be selected to edit details such as names, role, email and contact numbers. Selection of arming privileges tab 3024 displays zone arming privilege sections 3026 (for example: office arming privilege section 3026-1, reception arming privilege section 3026-2, and warehouse arming privilege section 3026-3), each having a ‘select all’ checkbox 3028 and sub-zone checkboxes 3030. The checkboxes 3028 and 3030 may be used to set arm/disarm privileges for the user profile, to arm or disarm alarm condition sensors 1120 in the respective zones and/or subzones.

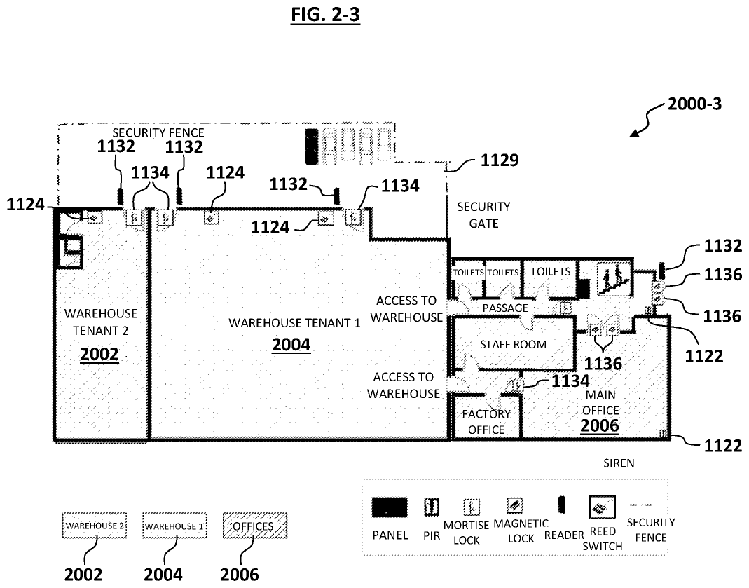

FIG. 4-1 shows a third user interface 4000 of the app, where the user has arm/disarm privileges allowing them to arm or disarm alarm condition sensors 1120. The third user interface 4000 displays a plurality of zone sections 4002, each having a status indicator 4004 visually displaying the arming status of the associated zone. On selection of a drop-down option 4006, sub-zone checkboxes 4008 are displayed to allow the user to select which sub-zones or areas of the site should be armed. In the example shown, only a first sub-zone checkbox 4008-1 is selected before selecting an arming confirmation button 4010. As shown in FIG. 4-2, the status indicator 4004 of the first zone section 4002-1 is updated from a “disarmed” status to indicate that the zone is “part armed”. A confirmation banner 4012 is displayed at the bottom of the user interface 4000 as a further confirmation of the action taken.

For each zone section 4002 in which at least one sub-zone remains disarmed, a zone arm button 4014 is provided, selection of which arms all sub-zones of the zone section 4002. Conversely, for each zone section 4002 in which at least one sub-zone is armed, a zone disarm button 4016 is provided, selection of which disarms all sub-zones of the zone section 4002. In this example, on selection of the zone arm button 4014 of the second zone section 4002-2, the status indicator 4004 of the second zone 4002-2 is updated to an “armed” status and a confirmation banner 4012 displayed (as shown in FIG. 4-3). The user interface 4000 further provides an arm site button 4016 and a disarm site button 4018, selection of which arms or disarms all of the zones. FIG. 4-4 depicts the user interface 4000 after the arm site button 4016 has been selected, noting that the status is only updated on confirmation of the selected action having actually occurred at the control unit 1102.

In examples, the security management service 1200 may issue notification to one or more authorized users of armed or disarmed status under predetermined conditions. For example, a notification may be issued if the system 1100 has not been armed (or is disarmed) at predetermined times and/or days. For example, the security management service 1200 may issue a notification the site is not armed or has been disarmed outside of business hours.

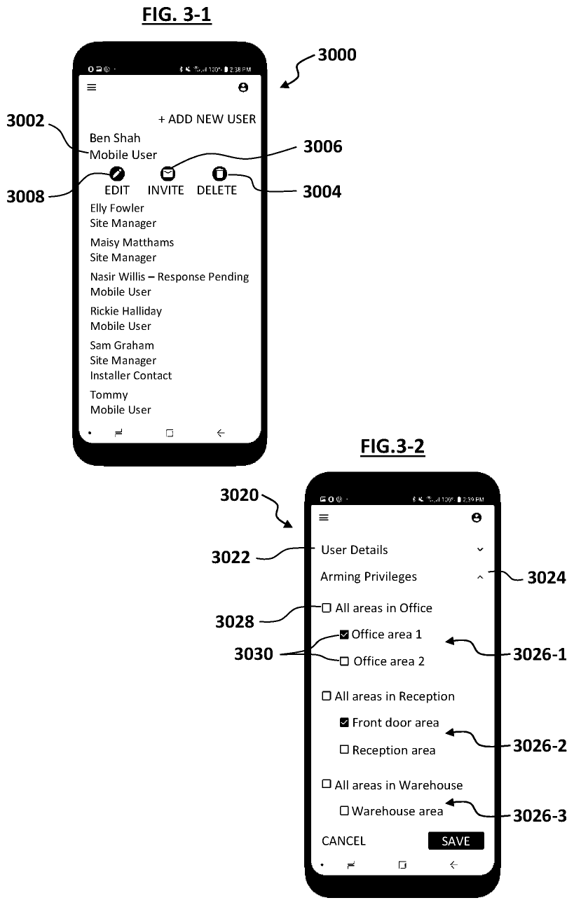

When a security system 1100 is armed and an alarm condition is detected, the control unit 1102 communicates the alarm condition to the security management service 1200. The security management service 1200 delivers an alarm notification to designated users. In examples, individual customer users may be able to selectively designate themselves as being available or unavailable to attend to alarm notifications, in which case the alarm notification is only delivered to available users (noting that the security management service 1200 may issue a warning when all designated users attempt to record themselves as being unavailable during a time period). The alarm notification may be issued directly via the app operating on a customer smartphone 1400, or may be accompanied with another form of communication (such as a SMS message, email, or call to the users) to draw their attention to the notification. On accessing the app each user is presented with an event stream user interface 5000, for example as illustrated in FIG. 5-1, in which a chronological stream of events in the system 1000 is displayed. For example, the interface 5000 may display alarm events 5002, each indicating the time of the event and the alarm condition sensor 1120 associated with the event. The interface 5000 may also display user events 5004, each indicating the individual who has claimed responsibility for the preceding alarm event(s) and the timing of same.

For unclaimed alarm events 5002, the user may select a claim button 5006 to assume responsibility for responding to the alarm event(s) 5002. A user who has claimed an alarm event may be referred to herein as a “command user”. Referring to FIG. 5-2, on claiming the alarm event(s) 5002 the command user is provided with a selectable event response button 5008 for display of an expanded options menu (not illustrated). The user can elect to close the alarm event, or escalate the alarm event.

In examples, the security management service 1200 may deliver video from the video camera(s) 1128 for viewing within the app to assist with decision making.

In examples, the security management service 1200 may be configured to determine a likelihood of the alarm event being false—i.e. not relating to an actual security issue—and indicate this likelihood in the app. For completeness, it should be appreciated that this may be expressed in the inverse form—i.e. a likelihood of being true. For example, the alarm event(s) 5002 may have an associated visual indication of such a condition—i.e. the alarm event 5002 may be flagged in the interface 5000. Selection of such a flag may provide additional information for the user's consideration. In exemplary embodiments the flag may be expressed as a probability, for example: a percentage likelihood, or on a scale of low to high likelihood.

In examples, historical events within the system 1000 may be used in the determination. As an example, an alarm notification issued in response to a particular alarm condition sensor 1120 being triggered may include a flag that previous recent triggers of that sensor 1120 proved to be false.

In examples, the presence or absence of alarm notifications from other alarm condition sensors 1120 may be used in the determination. For example, if an alarm notification has issued following triggering of an alarm condition sensor 1120 from a location in which other alarm notifications would be expected (e.g. a PIR motion detector 1122 in an area where an intruder would have been expected to pass other PIR motion detectors 1122), this may be used to determine a higher likelihood of the alarm notification being false. Conversely, multiple sensor triggers may be used to determine a higher likelihood that the alarm notification is not false.

In examples, data from other alarm condition sensor 1120 may be used in the determination. According to one aspect of this, where an alarm condition sensor 1120 has been triggered, video from the video camera(s) 1128 may be analyzed to, for example: a) identify the presence of one or more persons at the site, b) determine whether an individual is a known staff member or otherwise authorized personnel (for example, through automated facial recognition and comparisons made to stored images of staff with permissions for the zone which is the source of the alarm trigger), c) perform behavior analysis to detect unusual or suspicious actions, or d) identify that the source of the trigger is likely non-human (for example a bird, rodent, or other animals).

In examples, environmental data may be used in the determination. For example, the security management service 1200 may be in communication with a weather monitoring service, and current weather conditions may be factored into the determination—such as electrical storms increasing a likelihood of false triggering of alarm condition sensors 1120.

It is envisaged that accurate prediction of the likelihood of an alarm event being false (i.e. having a low incidence of false positives) may allow for alarm notifications to be reliably issued directly to security providers, or emergency responders, or to customers.

The app may also provide means for customer users to message each other to provide additional information—for example an acknowledgement that they have accidentally triggered an alarm. Such messages may also be displayed within the interface 5000

In the event that the command user claiming the alarm incident is in a position to sign off on the alarm notification being attended to without escalating the event further, they may select an option to close the alarm event which indicates the nature of the event: for example, due to maintenance, or a false alarm.

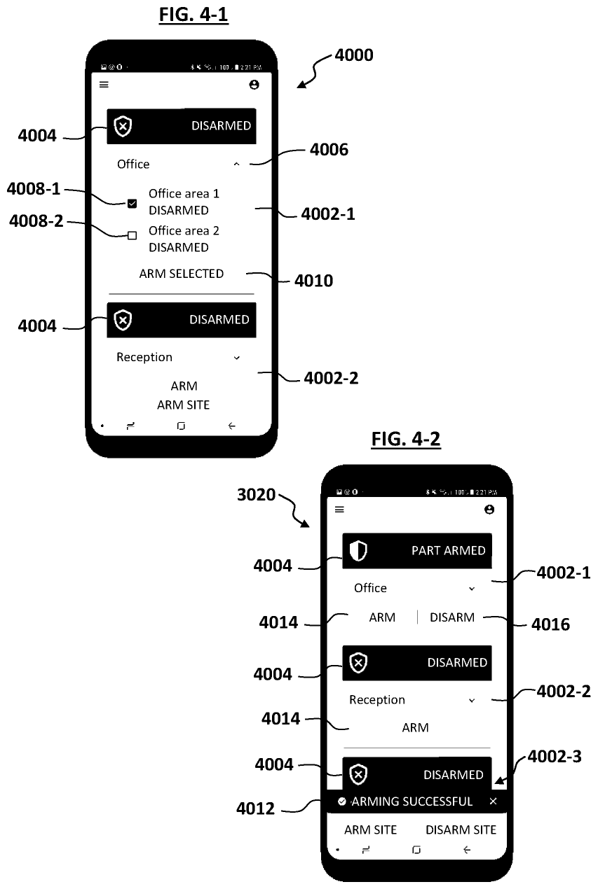

This may be captured in an event report 6000, shown in FIG. 6, in which a chronological sequence of actions is presented including individual alarm events 5002 and user events 5004. An event report conclusion 6004 is also provided in this example, summarizing the conclusion the event: namely the identity of the command user, the time and date, and the identified reason given for the alarm event.

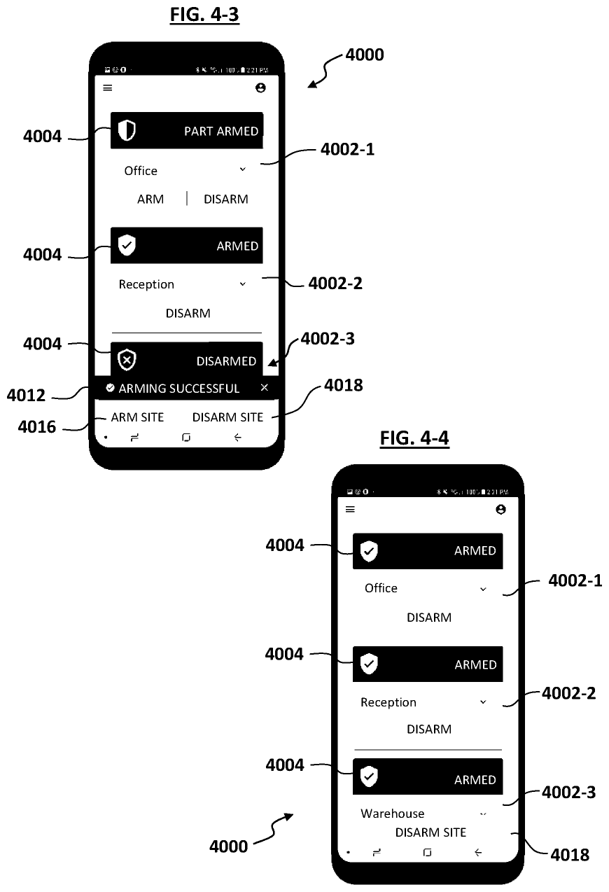

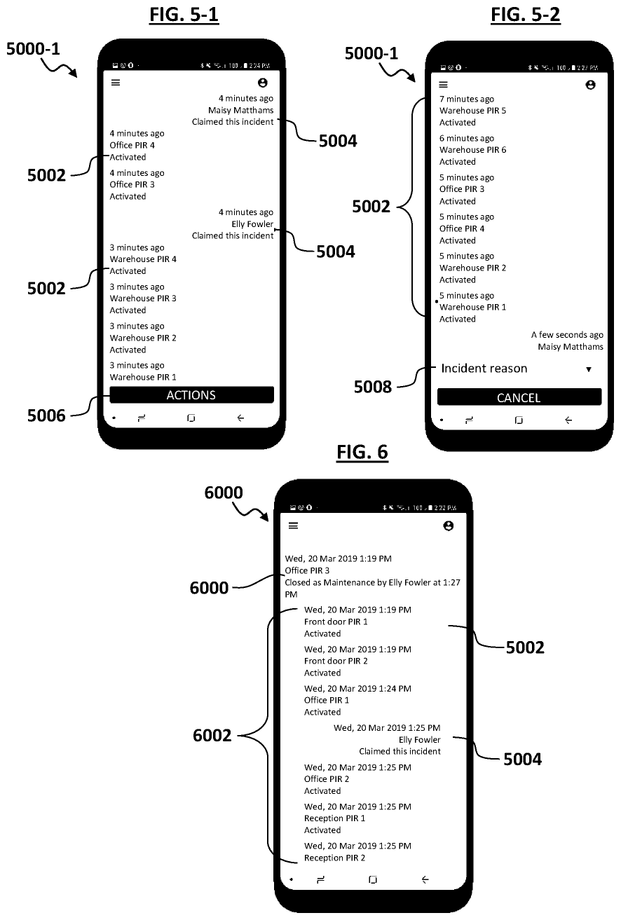

In some cases, it may be desirable to escalate the event—for example by having security response personnel attend the site to investigate the cause of the alarm event and secure the site. It is envisaged that aspects of the present technology may be particularly suited to cases in which the security response is provided by a contracted security service, allowing the customer's personnel to triage alarm notifications and determine whether escalation of the event is justified. FIG. 7-1 describes an exemplary process 7000 for requesting a security response. In a first step 7002 an alarm notification is issued to designated users, as described above. In a second step 7004, the security management service 1200 monitors for whether the alarm notification is claimed by a user. If so, and the command user indicates that a security response is desired, a request to attend the site is issued to a security provider (or at least an individual security responder of the security provider) by security management service 1200 in third step 7006—for example, via a notification to smartphones 1402, or to a control center of the security provider. In a fourth step 708, the security provider (or an individual security responder of the provider) claims responsibility for attending the site to investigate the alarm event. In the second step 7004, if the alarm notification is not claimed by a user, the security management service 1200 monitors a timer in a fifth step 7010. The timer may be configured by the customer according to their specifications. On expiry of the timer, in a sixth step 7012 the security management service 1200 issues an automated request for the security provider to have personnel attend the site, which is claimed by the security provider (or an individual security responder of the provider) in step 7008.

In examples, the security management service 1200 may allow for selection between a plurality of potential security responders, whether automatically based on predefined criteria or on consideration by a command user. In examples, potential security responders may have previously indicated their current availability to the security management service 1200, for example via responder smartphones 1402. In examples, the security management service 1200 may issue an availability query to listed potential security responders, and record them as being currently available on receiving an affirmative response. In examples, the security management service 1200 may automatically designate the security responder as being unavailable while they are registered as attending to a request to attend a different site.

In examples, the security management service 1200 may present one or more characteristics of each available potential security responder for consideration by the command user. Such characteristics may include, for example, one or more of: price (whether according to a fee schedule or based on previous events recorded with the security management service 1200), an indicator of likely response time, customer satisfaction rating (whether via the security management service 1200 or external sources of business ratings), performance metrics based on responses to prior events (for example: response times, time on-site, compliance with protocols such as reporting). In examples, the characteristics may be provided in a form relative to other security responders, such as a ranking. For completeness, it should be appreciated that one or more of the characteristics will be of the security service to which an individual security responder belongs, while others will be of the individual—for example, the indicator of likely response time).

In examples, the security management service 1200 may project the arrival time of potential security responders as a factor for selection. For example, one potential security responder may be closer geographically to the site, but likely slower to arrive than another due to factors such as roading and traffic conditions. Such capabilities may be provided through external predictive travel times services. However, in examples the location of the potential security responders may be used as the indicator of likely response time. FIG. 7-2 illustrates an exemplary scenario 7500 in which three security responders 7502 which are recorded as being currently active with the security management service 1200 are shown. Each security responder 7502 may have a projected travel route 7504 to a site 2000 having an alarm event, based on a current geographical location of the security responder 7502. The first security responder 7502-1 may be the closest option, with a fastest predicted response time, but be currently recorded as being unavailable for selection (for example, due to currently being involved in another alarm event). The second security responder 7502-2 may be closer to the site 2000 than the third security responder 7502-3, but have a slower predicted response time due to the nature of the travel route 7504 and current traffic conditions. For completeness, it is noted that the second security responder 7502-2 may still be selected based on other characteristics.

In examples where the security management service 1200 is issuing an automated request, the predefined criteria on which a selection is made may be specified by the customer. Such criteria may include the characteristics discussed above, along with others (for example, preferred security service).

On acceptance of the security responder's acceptance of the request in step 7008 of the process 7000, the security management service 1200 awaits confirmation of the responder's arrival at the site. In examples, the security management service 1200 may track the location of the security responder (for example using GPS or alternative mobile phone tracking techniques). The security management service 1200 may provide an indication of the security responder's location to the customer (for example, on a map and/or an estimated time of arrival based on location).

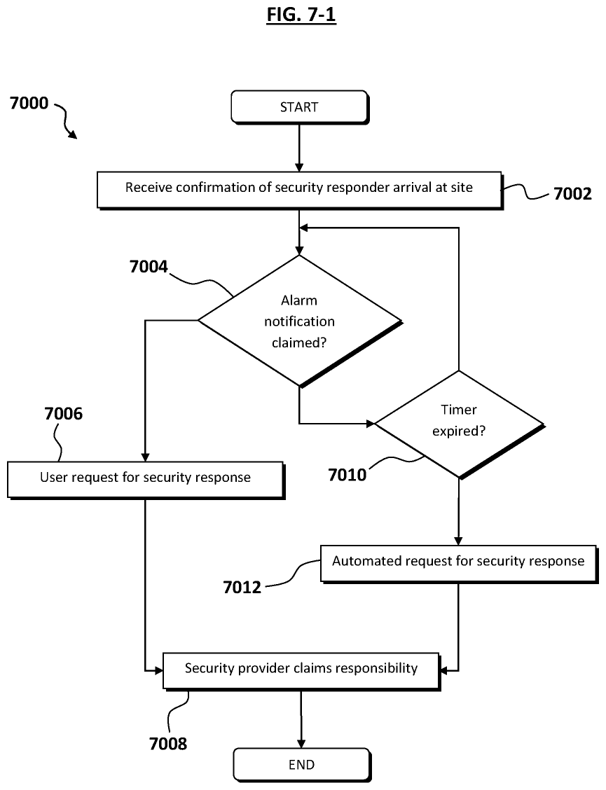

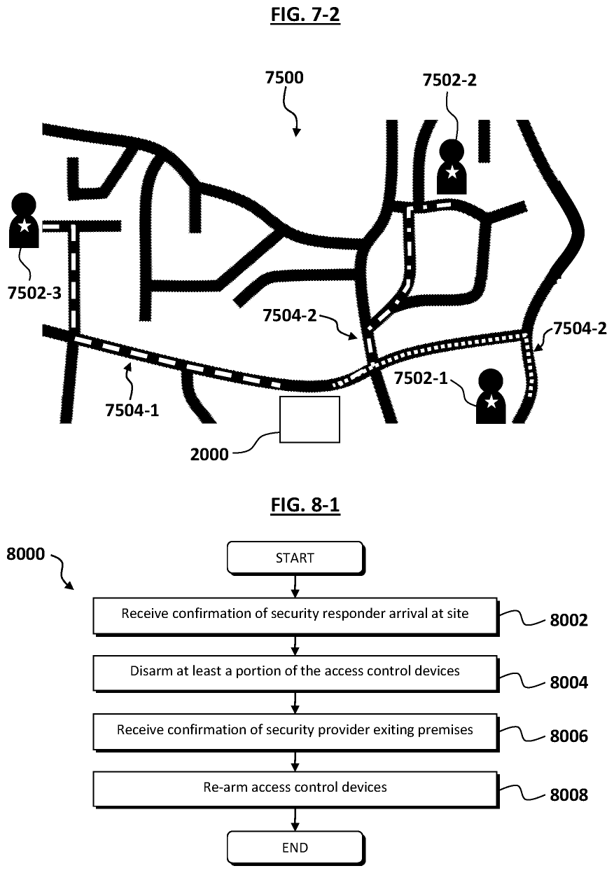

FIG. 8-1 illustrates a first exemplary process 8000 for providing a security responder access to a site. In this example the security responder indicates their arrival at the site to the security management service 1200 via the app on the responder's smartphone 1402 in first step 8002. FIG. 8-2 illustrates a user interface 8050 in which the event record 5002 shows the originating alarm event 8054, a first user event 8060 in which a user of the customer claims the alarm event, a second user event 8062 in which the user silences on-site response devices 1140, and a third user event 8064 in which the user requests a security responder attend the site (noting that this particular arrangement is shown for illustrative purposes, as it is unlikely that the user would silence the on-site response devices 1140 while remaining sufficiently concerned about the presence of an intruder so as to make the request to the security responder). A first security responder event 8070 shows acceptance of the request by a security responder, and a second security responder event 8072 shows that the security responder has arrived at the site.

Returning to FIG. 8-1, in second step 8004 the security management service 1200 disables at least a portion of the access control devices 1130 (and security alarm devices 1120 where applicable) to allow the security responder to access the site. In examples, only access control and security alarm devices of select areas on the site may be disabled—more particularly the area(s) in which alarm conditions have been detected. In examples, the security management service 1200 may await approval from the command user prior to disabling any of the access control devices 1130 and/or security alarm devices 1120. Once the security responder has confirmed their intention to exit from the site in a third step 8006, via the app on the responder's smartphone 1402, the security management service 1200 re-arms the access control devices 1130 and security alarm devices 1120 in order to secure the site in fourth step 8008. Before leaving the site the responder confirms the site is secure via visual display on site devices such as readers 1132 or via a status update from the security management service 1200 on the app on the responder's smartphone 1402.

Alternatively, the access control devices 1130 may be re-armed based on the geo-coordinates or movements of the responder, from which it may be reliably inferred that the responder has left the site. Such a re-arming may be performed automatically, or on approval by the command user.

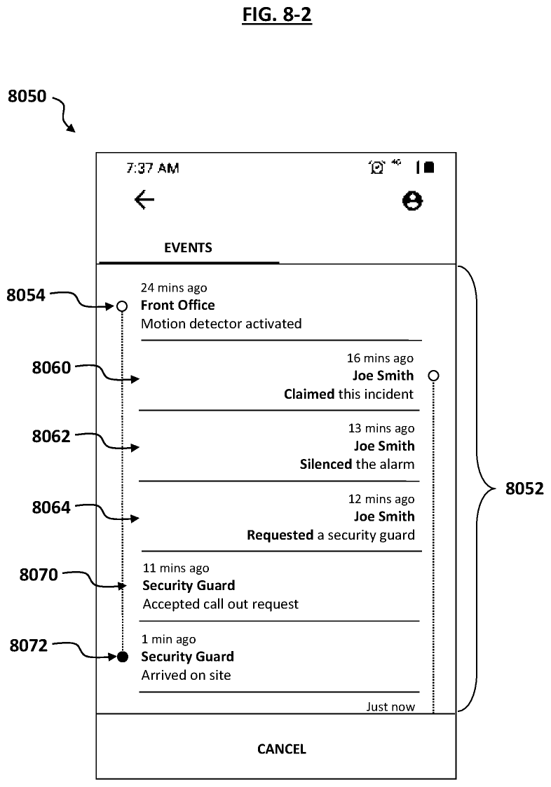

FIG. 9 illustrates a second exemplary process 9000 for providing a security responder access to a site. In this example the security responder indicates their arrival at the site to the security management service 1200 via the app on the responder's smartphone 1402 in first step 9002. In second step 9004 the security management service 1200 enables or otherwise provides a security credential on the responder's smartphone 1402, allowing the responder to present the smartphone 1402 to a reader 1132 to disable the on-site security system 1100 and allow the security responder to access the site. The credential on the responder's smartphone 1402 may allow them to securely authenticate with either the security management service 1200 or the on-site security system 1100; either option allowing the responder to access the site with the same privilege level. In the case where the responder's smartphone 1402 communicates with the security management service 1200, the security management service 1200 enables the required access at the on-site security system 1100. In an alternative embodiment, the credentialled smartphone 1402 may need to be presented at each reader 1132 to gain access to that area or zone. In examples, the security responder may be provided with temporary privileges around arming and disarming elements of the on-site system 1100 (for example, as illustrated by the third user interface 4000). Once the security responder has confirmed their intention to exit from the site in a third step 9006, via the app on the responder's smartphone 1402 or presentation of the smartphone 1402 at an exit reader 1132, the disarmed elements of the on-site system 1100 are re-armed in order to secure the site, and the on-site security system 1100 or the security management service 1200 disables or otherwise removes the security credential on the responder's smartphone 1402 in fourth step 9008. In examples, if the on-site system 1100 fails to re-arm, the credential is not disabled—maintaining the responder's privileges until they have confirmed that the site is secure.

In examples, the security management service 1200 directs the security responder to the site—for example, providing at least an address of the site. Further information may also be provided. For example, the security management service 1200 may provide geo-coordinates of most recently triggered alarm condition sensors 1120 to enable the security responder to directly attend that location. In an example the security responder may be provided with a map of the site. Animations or other visual indications may be used to indicate the location of at least the latest alarm condition sensor 1120 to be triggered on the site map. In examples, the map may visualize a progression of alarm condition sensors 1120 being triggered to assist with tracking progress of an intruder.

In examples, the security responder may enter updates as to the current status of the investigation to the security management service 1200 via the responder's smartphone 1402. In examples, the security responder may provide such information to a system of the security provider. The security management service 1200 may interface with the security provider system (for example, using an API) to obtain this information indirectly. Such updates may include, for example: text-based notes, voice clips, images and/or video. Where the security responder is carrying a body camera, video from the body camera may be accessible via the security management service 1200. In examples, such details may be provided to the security management service 1200 after the site inspection has been completed—however it is envisaged that the updates may be displayed to the customer users in real-time (or at least near real-time) as they are received in order to inform the customer of the current status of the incident.

In examples, the command user may be provided with selectable options for ongoing services from the security provider or individual security responder—for example, posting a guard following attendance to the site, to act as a deterrent to further intruder activity.

In examples, the security management service 1200 may transmit a notification of the alarm event to a wider group of customer personnel beyond those who are authorized to claim alarm events. Such a notification may alert the customer personnel to the occurrence of a potential intruder event. For example, the notification may be transmitted to personnel who are believed to be on-site, or due to arrive at the site, allowing them to take steps to secure their safety. In examples, the notification may be delivered in a form such as a SMS message, email, or call—although it is also contemplated that the notification may be issued directly via the app on a customer smartphone 1400. In examples, a notification of an alarm event may be sent to customers of other sites as a warning that there are intruders operating in the area, allowing for proactive defensive actions to be taken such as dispatch of security responders or issuing of alerts to people working on the other sites. Such notifications may include images of intruders captured at the original site where the alarm event first occurred.

In examples, the security management service 1200 may provide a safety escort request function via the app. It is envisaged that privileges for individual users maintained by the security management service 1200 may include authorization to request a safety escort. As described with reference to selection of a security responder, the user may be able to select between a plurality of potential safety escorts based on characteristics such as likely arrival time, and price. Once the safety escort is requested, the current location of the safety escort may be tracked and provided to the requesting user. The requesting user may confirm arrival of the safety escort, and conclusion of the escort service, via their smartphone 1400.

As described above, the security management service 1200 may record and display events occurring within the system 1000 in a live feed, providing a dynamic report of alarm events, customer actions, and service provider actions (such as security responders and/or safety escort services) as they occur.

On conclusion of the event (for example, on confirmation by the command user) the security management service 1200 may provide reports on the event. Such reports may focus on specific aspects of the event (for example, response times of customer users or security responders), however it is also envisaged that reports may capture all events from the various aspects of the system 1000—for example as shown in FIG. 6 and FIG. 8-2. It is envisaged that such complete reports may be useful for reporting to external parties such as police, in making insurance claims, and verifying contracted services for billing purposes. Currently such reports are constructed post-event, relying on the recollection of the individuals involved or at least manual discovery, review, and collation of digital events.

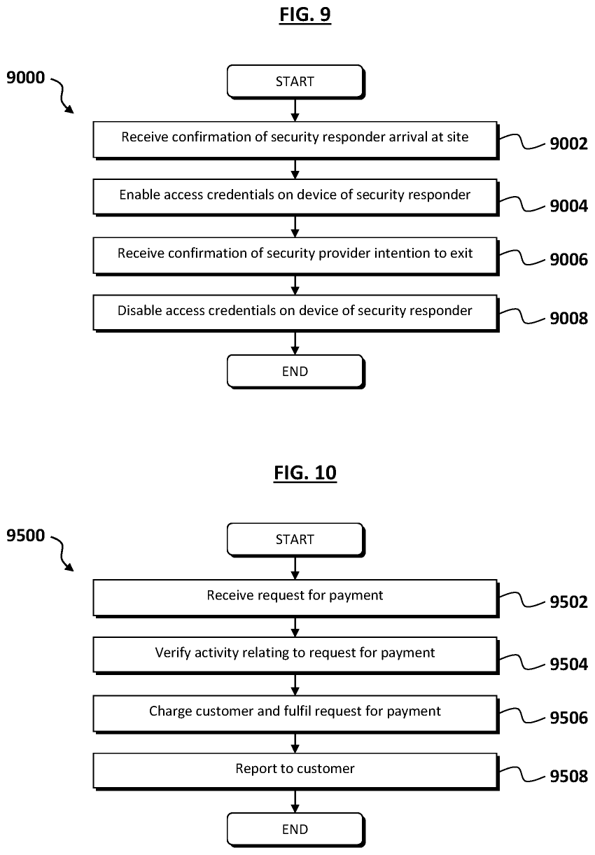

In examples, the security management service 1200 may provide a payment request service—for example, by use of security response services or safety escort services. FIG. 10 illustrates a method 950 for fulfilment of that payment request. In a first step 9502 the request for payment is received—for example an invoice to the security management service 1200 specifying the event to which the invoice relates. In an example, each event may be ascribed a unique identifier which may be cited by the party requesting payment. In a second step 9504 the security management service 1200 verifies the service for which payment is requested. For example, the event record may be reviewed to confirm that a request was made, that the request was fulfilled (for example through confirmation of attendance and subsequent exit by a security responder), and potentially customer signoff of the event. In a third step 9506, the security management service 1200 may charge the customer (for example, credit card deduction or direct debit) for the verified service and fulfil the request for payment. In a fourth step 9508 the security management service 1200 reports payment to the customer, for example accompanied by a receipt.

For a firmware and/or software (also known as a computer program) implementation, the techniques of the present disclosure may be implemented as instructions (for example, procedures, functions, and so on) that perform the functions described. It should be appreciated that the present disclosure is not described with reference to any particular programming languages, and that a variety of programming languages could be used to implement the present invention. The firmware and/or software codes may be stored in a memory, or embodied in any other processor readable medium, and executed by a processor or processors. The memory may be implemented within the processor or external to the processor. A general purpose processor may be a microprocessor, but in the alternative, the processor may be any processor, controller, microcontroller, or state machine. A processor may also be implemented as a combination of computing devices, for example, a combination of a digital signal processor (DSP) and a microprocessor, a plurality of microprocessors, one or more microprocessors in conjunction with a DSP core, or any other such configuration. The processors may function in conjunction with servers, whether cloud based or dedicated, and network connections as known in the art.

In various embodiments, one or more cloud computing environments may be used to create, and/or deploy, and/or operate at least part of the software system that can be any form of cloud computing environment, for example: a public cloud, a private cloud, a virtual private network (VPN), a subnet, a Virtual Private Cloud (VPC), or any other cloud-based infrastructure known in the art. It should be appreciated that a service may utilize, and interface with, multiple cloud computing environments.

The steps of a method, process, or algorithm described in connection with the present disclosure may be embodied directly in hardware, in a software module executed by one or more processors, or in a combination of the two. The various steps or acts in a method or process may be performed in the order shown, or may be performed in another order. Additionally, one or more process or method steps may be omitted or one or more process or method steps may be added to the methods and processes. An additional step, block, or action may be added in the beginning, end, or intervening existing elements of the methods and processes.

The illustrated embodiments of the disclosure will be best understood by reference to the figures. The foregoing description is intended only by way of example and simply illustrates certain selected exemplary embodiments of the disclosure. It should be noted that the flowchart and block diagrams in the figures illustrate the architecture, functionality, and operation of possible implementations of systems, apparatuses, methods and computer program products according to various embodiments of the disclosure. In this regard, each block in the flowchart or block diagrams may represent a module, segment, or portion of code, which includes at least one executable instruction for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The entire disclosures of all applications, patents and publications cited above and below, if any, are herein incorporated by reference. Reference to any prior art in this specification is not, and should not be taken as, an acknowledgement or any form of suggestion that that prior art forms part of the common general knowledge in the field of endeavour in any country in the world.

The invention(s) of the present disclosure may also be said broadly to consist in the parts, elements and features referred to or indicated in the specification of the application, individually or collectively, in any or all combinations of two or more of said parts, elements or features. Where in the foregoing description reference has been made to integers or components having known equivalents thereof, those integers are herein incorporated as if individually set forth.

Furthermore, the described features, structures, or characteristics may be combined in any suitable manner in at least one embodiment. In the foregoing description, numerous specific details are provided to give a thorough understanding of the exemplary embodiments. One skilled in the relevant art may well recognize, however, that embodiments of the disclosure can be practiced without at least one of the specific details thereof, or can be practiced with other methods, components, materials, et cetera. In other instances, well-known structures, materials, or operations are not shown or described in detail to avoid obscuring aspects of the invention.

Throughout this specification, the word “comprise” or “include”, or variations thereof such as “comprises”, “includes”, “comprising” or “including” will be understood to imply the inclusion of a stated element, integer or step, or group of elements integers or steps, but not the exclusion of any other element, integer or step, or group of elements, integers or steps, that is to say, in the sense of “including, but not limited to”.

Aspects of the present disclosure have been described by way of example only and it should be appreciated that modifications and additions may be made thereto without departing from the scope thereof.

1. A computer-implemented method of managing an alarm event using a security system including an on-site security system including one or more alarm condition sensors and at least one site control unit configured to communicate with the alarm condition sensors, and a security management service located remotely from the on-site security system and configured to communicate with the site control unit and at least one authorised user associated with the on-site security system, the method including:
issuing an alarm notification to at least one authorised user, the alarm notification identifying at least: a sensor triggering issuance of the alarm notification, a location of the sensor, and a time of the sensor being triggered;
monitoring for acknowledgement of the alarm notification from the authorised user; and
issuing a response request to at least one security responder in the absence of an acknowledgement, wherein the response request directs the at least one security responder to attend a site location associated with the on-site security system.

2. The method of claim 1, further including:
receiving an arrival notification from the security responder advising arrival at the site location;
deactivating at least a portion of an access control system of the on-site security system;
receiving a departure notification from the security responder advising intended departure from the site location; and
activating the access control system.

3. The method of claim 2, further including automatically activating the access control system in the absence of the departure notification from the security responder on a predetermined condition being met.

4. The method of claim 3, wherein the predetermined condition includes one or more of: expiry of a predetermined time period, and a geolocation of the security responder indicating exit from the site location.

5. The method of claim 1, further including:
receiving an arrival notification from the security responder advising arrival at the site location;
activating access control permissions of a device of the security responder, the access control permissions allowing at least partial control of an access control system of the on-site security system;
receiving a departure notification from the security responder advising intended departure from the site location; and
disabling the access control permissions of the device of the security responder.

6. The method of claim 1, further including:
determining an in-site location of at least one sensor triggering issuance of the alarm notification; and
communicating an indication of the in-site location to the security responder.

7. The method of claim 1, wherein issuing a response request to at least one security responder includes selecting between a plurality of potential security responders based on one or more characteristics.

8. The method of claim 7, wherein the one or more characteristics include: an indication of availability, price, an indicator of likely response time, a customer satisfaction rating, and one or more performance metrics based on responses to prior events.

9. The method of claim 1, further including:
receiving an acknowledgement of the alarm notification from the authorised user;
receiving a user response request from the authorised user and issuing the response request to the at least one security responder
receiving at least one notification of security responder activity, including details of at least: time of the at least one security responder acknowledging the response request, time of arrival at the site location, and time of departing the site location; and
generating an incident report, including a sequential record of the issuance of the alarm notification, the acknowledgement of the alarm notification, the issuance of the response request, and the at least one notification of security responder activity.

10. A security system including:
an on-site security system including:
one or more alarm condition sensors; and
at least one site control unit configured to communicate with the alarm condition sensors and the access control devices; and
a security management service located remotely from the on-site security system and configured to communicate with the site control unit and at least one authorised user associated with the on-site security system, the security management service including one or more processors and one or more non-transitory computer-readable media that collectively store instructions that when executed by the one or more processors cause the service to perform operations including:
issuing an alarm notification to the at least one authorised user, the alarm notification identifying at least: the alarm condition sensor triggering issuance of the alarm notification, a location of the alarm condition sensor, and a time of the alarm condition sensor being triggered;
monitoring for acknowledgement of the alarm notification from the authorised user; and
issuing a response request to at least one security responder in the absence of an acknowledgement.

11. The security system of claim 10, wherein the security management service further performs the operations of:
receiving an arrival notification from the security responder advising arrival at the site location;
deactivating at least a portion of an access control system of the on-site security system;
receiving a departure notification from the security responder advising intended departure from the site location; and
activating the access control system.

12. The security system of claim 10, wherein the security management service further performs the operations of:
receiving an arrival notification from the security responder advising arrival at the site location;
deactivating at least a portion of an access control system of the on-site security system; and
automatically activating the access control system in the absence of a departure notification from the security responder on at least one predetermined condition being met.

13. The security system of claim 12, wherein the at least one predetermined condition includes one or more of: expiry of a predetermined time period, and a geolocation of the security responder indicating exit from the site location.

14. The security system of claim 10, wherein the security management service further performs the operations of:
receiving an arrival notification from the security responder advising arrival at the site location;
activating access control permissions of a device of the security responder, the access control permissions allowing at least partial control of an access control system of the on-site security system;
receiving a departure notification from the security responder advising intended departure from the site location; and
disabling the access control permissions of the device of the security responder.

15. The security system of claim 10, wherein the security management service further performs the operations of:
determining an in-site location of at least one sensor triggering issuance of the alarm notification; and
communicating an indication of the in-site location to the security responder.

16. The security system of claim 10, wherein issuing a response request to at least one security responder includes selecting between a plurality of potential security responders based on one or more characteristics.

17. The security system of claim 16, wherein the one or more characteristics include: an indication of availability, price, an indicator of likely response time, a customer satisfaction rating, and one or more performance metrics based on responses to prior events.

18. The security system of claim 10. wherein the security management service further performs the operations of:
receiving an acknowledgement of the alarm notification from the authorised user;
receiving a user response request from the authorised user and issuing the response request to the at least one security responder
receiving at least one notification of security responder activity, including details of at least: time of the at least one security responder acknowledging the response request, time of arrival at the site location, and time of departing the site location; and
generating an incident report, including a sequential record of the issuance of the alarm notification, the acknowledgement of the alarm notification, the issuance of the response request, and the at least one notification of security responder activity.
